(19) United States
(12) Patent Application Publication
(10) Pub. No.: US 2006/0039346 A1
(43) Pub. Date: Feb. 23, 2006

(54) Transmitting information through a communication link and monitoring link quality

(76) Inventor: Israel Shapiro, Kelowna (CA)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/207,436

(22) Filed: Aug. 18, 2005

Related U.S. Application Data
(60) Provisional application No. 60/602,365, filed on Aug. 18, 2004.

(51) Int. Cl. H04J 3/24

(52) U.S. Cl. 370/349; 370/333

(57) ABSTRACT

A method transmits information from a transmitting device to a receiving device through a communication link. The method includes monitoring a link quality of the communication link at the receiving device, sending a respective link quality notification from the receiving device to the transmitting device, and adapting, at the transmitting device, transmission parameters for the transmission of information based on the link quality notification received from the receiving device.

### CROSS-REFERENCE TO RELATED APPLICATIONS

This Non-Provisional Application claims the benefit of the filing date of Provisional U.S. Patent Application Ser. No. 60/602,365, entitled “METHOD FOR TRANSMITTING INFORMATION THROUGH A COMMUNICATION LINK AND RESPECTIVE TRANSMITTING DEVICE AND COMMUNICATION SYSTEM,” having Attorney Docket No. I435.111.101/14551US, and having a filing date of Aug. 18, 2004, and which is herein incorporated by reference.

### BACKGROUND

There are many methods for transmitting information through a communication link/channel, such as a wireless communication channel, as well as a respective transmitting device and a communication system, such as a wireless communication system, comprising such a transmitting device.

Several conventional techniques for establishing a pre-defined transmission quality or link quality in communication systems are known. In some of these conventional techniques, pre-defined “Quality of Service” (QoS) parameters are defined, and a transmitting device (e.g., a mobile phone) transmits a request to a receiving device (e.g., a base station) to transmit a set of link quality indications from the receiving device to the transmitting device so as to adjust its own transmission parameters accordingly. According to these conventional techniques, it is only the transmitting device which initiates such a link quality control, while the receiving device is not even aware of the pre-defined and required QoS parameter values which should be kept for a high quality transmission of information.

This, however, has the consequence that the transmitting device may use only the respective pre-defined set of link quality parameters/measures, such as bit error rate (BER) and received signal strength information (RSSI), and the algorithm used for adapting the link quality is relatively coarse and not flexible.

### SUMMARY

One aspect of the present invention provides a method of transmitting information from a transmitting device to a receiving device through a communication link. The method includes monitoring a link quality of the communication link at the receiving device. The method includes sending a respective link quality notification from the receiving device to the transmitting device. The method includes adapting, at the transmitting device, transmission parameters for the transmission of information based on the link quality notification received from the receiving device.

### BRIEF DESCRIPTION OF THE DRAWINGS

FIG. 1 illustrates a simplified block diagram of a communication system according to the one embodiment.

FIG. 2 illustrates a flowchart illustrating one embodiment of the transmission of information in the communication system of FIG. 1.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

A method is disclosed for transmitting information through a communication link from a transmitting device to a receiving device as well as a respective transmitting device and a respective communication system, which allow for an improved and more flexible link quality adaptation/link quality adjustment.

In one embodiment, a method transmits information between a transmitting device and a receiving device through a communication link, such as a wireless communication link, where the receiving device itself monitors the reception quality of the communication channel, such as in regular intervals, and transmits a respective notification on the current reception quality/link quality to the transmitting device.

In one embodiment, the notification sent by the receiving device to the transmitting device may comprise information on an action to be taken by the transmitting device to improve the reception quality, such as changing the data rate or the transmit power etc. In one embodiment, the notification regarding the reception quality/link quality also includes particular values for transmission parameters to be adjusted accordingly by the transmitting device.

In one embodiment, it is not only the transmitting device which is aware of pre-defined QoS parameter values for the transmission of the information with a given quality, but also the receiving device is aware of these QoS parameter values. These QoS parameter values may comprise a mean data rate, a peak data rate, a jitter bound, a latency/delay bound, or a maximum error rate or a token bucket size/maximum burst size etc.

In one embodiment, it is the receiving device which proactively guides the transmitting device to adapt for a desired transmission quality. Thus, in this embodiment, the receiving device initiates the above notification in the form of signalling messages to the transmitting device in order to guide the transmitting device to adjust transmission parameters to achieve the desired transmission quality. Consequently, this embodiment is no longer required to use only a pre-defined set of link quality measures, like PER and RSSI, and it is also possible to implement a more flexible and finer adaptation algorithm.

Other embodiments may be realized independently from the above-mentioned transmission quality/link quality control. These further embodiments comprise notifications for upper protocol layers, such as in the transmitting device and in the receiving device, upon adjustments to configuration in response to link/channel quality changes. In particular, an upper protocol layer or the protocol adaptation layer (PAL) of the transmitting device may decide to adapt the data rate appropriately depending on the link quality notification received from the receiving device, or it may decide to drop the transmission completely.

Moreover, one embodiment calculates a required link/channel time based on the above QoS parameter values and the link quality notification as received from the receiving device.

Furthermore, one embodiment performs modification/update to reservations of link/channel time for specific transmissions according to the QoS parameter values and the link quality notification.

Embodiments may be used in wireless communication systems, such as the ultra-wideband technology, and may be employed in a multi-band OFDM alliance (MBOA) compliant media access controller (MAC) in which this involves modification/update to distributed reservation protocol (DRP) reservations that have been previously negotiated between the transmitting device and the receiving device to support use of exclusive link/channel time to maintain the required QoS for the connection that is monitored.

Embodiments may be used in wireless communication systems, such as the ultra-wideband technology according to the specifications of the WiMedia Alliance and the MBOA, implementing the QoS requirements or QoS parameters defined herein (e.g., mean data rate, peak data rate, jitter bound, latency/delay bound etc.). However, the present invention is not restricted to this field of technology, but it may be used in any communication system, in particular also in wired or optical communication systems, where a high transmission/link quality is desirable.

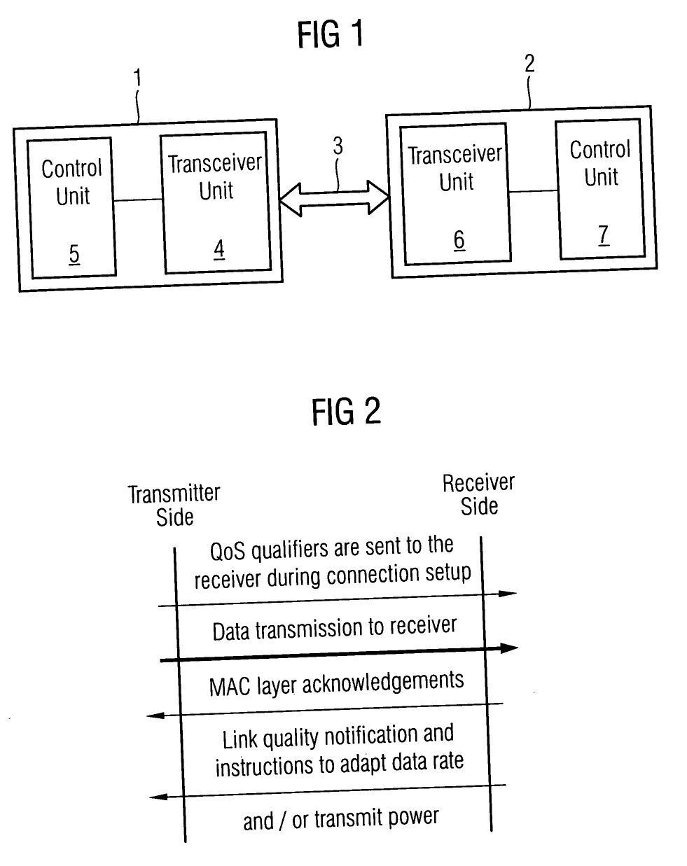

FIG. 1 illustrates one embodiment of a communication system, for example a wireless communication system, comprising a transmitting device 1 and a receiving device 2 being coupled by a communication channel/link 3 which in one embodiment is a wireless communication channel/link. For example, the communication system may be a communication system according to the ultra-wideband (UWB) technology, with each device including a MAC according to the MBOA specification, a WiMedia alliance MAC convergence architecture (WiMCA) layer, one or more PALs and one or more upper layer protocols. The transmitting device 1 is adapted to transmit information, which may include data, video and audio information, to the receiving device 2. The receiving device is adapted to receive this information through the communication link 3 for reproducing or processing the information.

As explained below, in one embodiment, a link quality notification is transmitted from the receiving device 2 to the transmitting device 1 through the communication link 3. Therefore, in this embodiment, the receiving device 2 does not only comprise a receiving unit, but a combined transmitting/receiving unit (transceiving unit) 6. Furthermore, in one embodiment the receiving device 2 comprises a control unit 7 which employs WiMCA device management entity (WiDME) and media access layer management entity (MLME).

The MLME provides the MAC layer management service interfaces for the layer management functions of the receiving device. In particular, the MLME provides an interface to higher layers through a set of primitives that define interactions between the higher layers and the MAC. The WiDME is an entity defined in the specification of WiMedia MAC convergence architecture (WiMCA) to provide device management as well as an interface to upper protocol layers and to utilize the MLME and physical layer (PHY) management entity (PLME) service interfaces provided by the MAC and the PHY layers to manage the device data transfer functionality and operation.

Similarly, in one embodiment, the transmitting device 1 comprises a combined transmitting/receiving section 4 and a control unit 5 comprising WiDME and MLME.

As regards the link quality control, in one embodiment, the receiving device 2 is proactive, which means that it constantly monitors the reception quality of the communication link 3. Both the transmitting device 1 and the receiving device 2 or the respective control units thereof are aware of those QoS parameter values that are required by upper layers for a transmission of information with a defined quality.

These QoS parameter values in one example comprise the mean data rate, the peak data rate, the jitter bound, the latency/delay bound, the maximum error rate, the token bucket size/maximum burst size etc. Depending on the predefined QoS for a set of transmission frames/packets, the mean data rate is the average rate at which data is transmitted, generally measured in Bytes per second. Peak data rate is the maximum rate at which data can be transmitted, generally measured in Bytes per second. Jitter is the variability of the actual time interval between frame transmissions around the mean time interval, and jitter bound corresponds to the maximum allowed deviation from this mean time interval value. The latency/delay bound is an upper bound on the interval between the transmission and the reception of a frame/packet, including the actual transmission time on the communication link 3 and additional buffering that may be necessary at the transmitting device 1 and/or receiving device 2 to allow for retransmissions that help to overcome interference and data loss on the communication link 3. The parameter token bucket size defines the size of a mechanism that limits the bandwidth by accumulating tokens in a fixed size bucket and then removing tokens per each transmitted unit (e.g., frame/packet). This is a common QoS mechanim that gives some degree of control over the long term average transmission rate and the momentary burst rate of a set of transmissions. The parameter maximum error rate relates to the rate of errors, generally measured in bits per second, that is occurring due to interference on the communication medium. An upper layer protocol will tolerate no more than a maximum rate of errors in order to maintain a required level of quality for the connection data.

In one embodiment, if the control unit 7 of the receiving device 2 recognizes that the link/reception quality diverges from these required QoS parameter values, it immediately responds by sending a respective link quality notification through the communication link 3 to the transmitting device 1 in order to keep the transmitting device 1 informed about the current link quality.

However, this link quality notification does not only inform the transmitting device 1 on the current status of the link quality of the communication link 3, but it also comprises particular instructions for the transmitting device 1 to take respective steps for improving the link quality. In particular, by means of this link quality notification, the receiving device 2 may instruct the transmitting device 1 to change its data rate or transmit power, for example. The link quality notification of the receiving device 2 may also include desired values for other transmission parameters to be adjusted by the transmitting device 1.

In contrast to other existing solutions where the receiving device constantly polls the transmitting device for information on the link quality, according to embodiments of the present invention there is no need to define a respective superset of link quality measurements. Instead, each implementer of the receiver side may select its own measurements that are available in the respective receiving device.

FIG. 2 illustrates a flowchart illustrating in more detail one embodiment of the transmission of information between the transmitting device and the receiving device.

As illustrated in FIG. 2, at first the QoS parameter values (QoS qualifiers) are sent from the transmitting device 1 to the receiving device 2 during a connection setup. As soon as the connection has been set up, during normal operation there is a dataflow from the transmitting device to the receiving device, and respective MAC layer acknowledgements are sent from the receiving device 2 to the transmitting device 1. Furthermore, during normal operation, the receiving device 2 monitors the reception quality of the communication link 3 and informs the transmitting device 1 on the current link quality. If found necessary, the receiving device 2 in particular instructs the transmitting device 1 to change its data rate and/or its transmit power in order to improve the link quality.

Irrespective of the above embodiments or in addition thereto, the following aspects may also be realized in the communication system of FIG. 1.

A common platform may be provided for all protocol adaptation layer (PALs) in the system. The PAL design can be simplified by decoupling it from the “Media Access Layer”/“Physical Layer” (MAC/PHY) low level issues in order to eliminate the need for dealing with MAC/PHY specific parameters like preamble durations, various inter frame spacing, fragment sizes, media access latencies etc.

The communication system may in particular be adapted to perform the following tasks: support connection setup/modify/teardown; ongoing communication link quality monitoring; automatic data rate and transmit power adjustments; notifications for upper layers upon link capability changes (e.g., when the boundaries for automatic data rate/transmit power adjustments are left); and correlation with the interference mitigation sub-entity for bandwith rebalancing and/or channel time relinquishing. Interference mitigation is one of the responsibilities of the WiDME entity and defines a behavior that should minimize the interference caused by one of the communication devices 1, 2 to a neighboring communication device which is not participating in the same coordinated use of the communication link 3, including rules for choosing the communication channel to operate on and rules for setting transmission power and transmission rate of the respective communication device 1, 2.

In one embodiment, the connection setup/modify/teardown aspect comprises providing a generic application programming interface (API) (i.e., a generic set of functions/parameters/software modules to be used for interfacing between the respective software blocks) for connection management, supporting the above-mentioned sufficient connection specific QoS parameter values, providing service primitives to abstract “MAC layer management entity”, “service access point” (MLME, SAP) primitives as much as possible, communicating with the target device so that it is aware of the connection establishment/update requested by the initiator and the target device is able to update the respective connection parameters, and calculate the required channel time based on the pre-defined QoS parameter values (qualifiers) and the link quality information in order to perform adequate link/channel time reservations such as through the distributed reservation protocol (DRP) mechanism. The DRP is a mechanism defined in the MBOA MAC standard Distributed Medium Access Control (MAC) for Wireless Networks and allows for the negotiation and reservation of the medium access time. In one aspect, this is provided by defining that the medium access time is divided into fixed cycles (i.e., superframes), each subdivided into time slots which are called “Medium Access Slots” (MAS). The communication devices 1 and 2 implementing the MBOA MAC may negotiate the use of individual MAS and reserve them for use between the negotiating communication devices 1, 2.

The communication link quality monitoring and the automatic data rate and transmit power adjustments were already discussed above in detail.

In one embodiment, the notification to the upper layers upon link quality changes, in particular out of the boundaries for the automatic data rate/transmit power adjustments, comprises that the PAL (i.e., the layer responsible for an adaptation of one specific protocol to another protocol) makes the decision either to reduce the data rate (i.e., lower resolution etc.) or to drop the transmission completely, if the link quality degrades. On the other hand, if the link quality improves, the PAL can make the decision to adjust the data rate appropriately, if it was previously reduced due to channel degradation and/or bandwidth management policies.

When correlating with the interference mitigation sub-entity for bandwidth rebalancing and/or channel time relinquishing, the PALs can be informed accordingly.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method of transmitting information from a transmitting device to a receiving device through a communication link, the method comprising:
monitoring a link quality of the communication link at the receiving device;
sending a respective link quality notification from the receiving device to the transmitting device; and
adapting, at the transmitting device, transmission parameters for the transmission of information based on the link quality notification received from the receiving device.

2. The method of claim 1, wherein sending the respective link quality notification comprises sending an instruction from the receiving device for the transmitting device to take action to improve the link quality of the communication link if the link quality monitored by the receiving device diverges from at least one pre-defined Quality of Service parameter value.

3. The method of claim 2, wherein the at least one pre-defined Quality of Service parameter value is selected from a group comprising a mean data rate, a peak data rate, a jitter bound, a latency bound, a delay bound, a maximum error rate, a token bucket size, and a maximum burst size.

4. The method of claim 1, wherein sending the respective link quality notification comprises sending a value for at least one transmission parameter of the transmitting device to be adjusted by the transmitting device.

5. The method of claim 4, wherein the at least one transmission parameter is selected from a group comprising a data rate and a transmit power of the transmitting device.

6. The method of claim 1, comprising:
notifying at least one upper layer of the transmitting device and/or the receiving device of link quality changes and/or link capability changes.

7. The method of claim 1, further comprising:
calculating a link time based on the link quality notification at the transmitting device and/or the receiving device.

8. The method of claim 7, wherein the link time is calculated based on at least one pre-defined Quality of Service parameter value.

9. The method of claim 1, comprising:
performing a link/channel time reservation adaptation based on the link quality notification at the transmitting device and/or the receiving device.

10. The method of claim 9, wherein the link/channel time reservation adaptation is performed based on at least one pre-defined Quality of Service parameter value.

11. The method of claim 1, wherein both the transmitting device and the receiving device are aware of at least one Quality of Service parameter value employed for the transmission of information.

12. A receiving device comprising:
a receiver unit configured to receive information from a transmitting device through a communication link;
a control unit configured to monitor a link quality of the communication link; and
a sender unit configured to send a respective link quality notification to the transmitting device.

13. The receiving device of claim 12, comprising:
a transceiver unit including the receiver unit and the sender unit.

14. A communication system, comprising:
a communication link;
a transmitting device coupled to the communication link and configured to transmit information through the communication link; and
a receiving device coupled to the communication link and configured to receive the information transmitted from the transmitting device through the communication link, wherein the receiving device is configured to monitor a link quality of the communication link and to send a respective link quality notification to the transmitting device.

15. The communication system of claims 14, wherein the transmitting device is configured to receive the link quality notification and is configured to adapt transmission parameters for the transmission of information based on the link quality notification received from the receiving device.

16. The communication system of claim 14, wherein the communication link comprises a wireless communication link.

17. The communication system of claim 14, wherein the communication link comprises an ultra-wideband communication link.

18. The communication system of claim 14, wherein the transmitting device and the receiving device comprise a media access controller (MAC) layer according to multi-band OFDM alliance (MBOA) specifications.

19. The communication system of claim 14, wherein the transmitting device and the receiving device comprise a WiMedia MAC convergence architecture (WiMCA) layer according to WiMedia specifications.

20. The communication system of claim 14, wherein the transmitting device is configured to receive the link quality notification, and the transmitting device comprises:
a protocol adaptation layer configured to decide, after the link quality notification is received, whether to adjust at least one transmission parameter for the transmission of information or to completely drop the transmission of information.

21. A communication system, comprising:
a communication link;
means for transmitting information through the communication link; and
means for receiving the information transmitted through the communication link, including:
means for monitoring a link quality of the communication link; and
means for sending a respective link quality notification.

22. The communication system of claims 21, wherein the means for transmitting information through the communication link comprises:
means for adapting transmission parameters for the transmission of information based on the link quality notification.

23. A receiving device comprising:
means for receiving information from a transmitting device through a communication link;
means for monitoring a link quality of the communication link; and
means for sending a respective link quality notification to the transmitting device.
